(19) United States
(12) Patent Application Publication
(10) Pub. No.: US 2026/0269117 A1
(43) Pub. Date: Sep. 10, 2026

(54) INDUCTOR, MADE FROM BUNDLED FIBERS, AND COMPONENTS, SYSTEMS AND METHODS

(71) Applicant: Murata Manufacturing Co., Ltd., Kyoto (JP)

(72) Inventors: Kazuhisa Sano, Saitama (JP); David M. Giuliano, Bedford, NH (US)

(21) Appl. No.: 19/662,862

(22) Filed: Apr. 29, 2026

Related U.S. Application Data
(63) Continuation of application No. PCT/US2024/053542, filed on Oct. 30, 2024.
(60) Provisional application No. 63/594,923, filed on Oct. 31, 2023.

(51) Int. Cl. H01F 27/24; H01F 41/02

(52) U.S. Cl. CPC H01F 27/24; H01F 41/0206

(57) ABSTRACT

A core for an inductor includes a plurality of axially fibers and an electrically insulating material disposed between the fibers. The core may be incorporated into an inductor, a transformer, or other electrical components. A method of making the core includes forming insulated fibers or bundles of insulated fibers.

### CROSS REFERENCE TO RELATED APPLICATIONS

This application is a continuation of International Patent Application No. PCT/US2024/053542 filed Oct. 30, 2024 and entitled “INDUCTOR, MADE FROM BUNDLED FIBERS, AND COMPONENTS, SYSTEMS AND METHODS,” which claims priority to and the benefit of U.S. Provisional Patent Application No. 63/594,923 filed Oct. 31, 2023 and entitled “INDUCTOR, MADE FROM BUNDLED FIBERS, AND COMPONENTS, SYSTEMS AND METHODS,” all of which are incorporated herein by reference in their entirety.

### TECHNICAL FIELD

The present disclosure relates to cores usable in inductors and other electrical devices, devices including such cores, and methods of making and using the same. More particularly, the disclosure relates to cores formed of a plurality of fibers.

### BACKGROUND

Inductors may be formed of a core and a conductive structure proximate the core (e.g., one or more windings). Eddy currents are generated in the core due to electromagnetic properties when a current is passed through the conductive structure. These eddy currents result in losses (e.g., heat) that worsen at high frequencies of, e.g., 40 MHz or higher. As such, there remains a need for a core structure capable of minimizing eddy current losses while maintaining material density.

### BRIEF SUMMARY

According to embodiments of the present disclosure, a core for an inductor includes a plurality of axially aligned fibers and an electrically insulating material disposed between the fibers of the plurality of fibers. The fibers may be formed of a metal or a metal oxide, such as a ferromagnetic material. The plurality of fibers may be transverse to a magnetic field within the core. An apparatus employing the core may further include a conductive structure in proximity to the core. The apparatus may be, for example, an inductor or a transformer.

A method of making the core includes providing an insulated wire formed of an electrically insulating material wrapped about a metal structure, wherein the metal structure comprises a metal wire or compacted metal powder and is formed of a metal or metal oxide, and drawing the insulated wire to form an insulated fiber comprising a continuous fiber having a diameter of 100 nm to 10 μm and a coating layer of the electrically insulating material disposed about the fiber. The method further includes combining a plurality of the insulated fibers such that they are axially aligned. The insulated fibers may be combined during or after the drawing process.

### BRIEF DESCRIPTION OF THE DRAWINGS

Various embodiments of the present disclosure will be understood more fully from the detailed description given below and from the accompanying drawings. In the drawings, like reference numbers may indicate identical or functionally similar elements. Embodiments are described in detail hereinafter with reference to the accompanying figures, in which:

FIG. 1 is a perspective view of an inductor according to an embodiment of the present disclosure.

FIG. 2A is a cross-sectional view of a core according to an embodiment of the present disclosure.

FIG. 2B is a partial enlarged view of FIG. 2A.

FIG. 3A is a cross-sectional view of a core according to an embodiment of the present disclosure.

FIG. 3B is a partial enlarged view of FIG. 3A.

FIG. 4A is a cross-sectional view of a core according to an embodiment of the present disclosure.

FIG. 4B is a partial enlarged view of FIG. 4A.

FIG. 5A is a cross-sectional view of a core according to an embodiment of the present disclosure.

FIG. 5B is a partial enlarged view of FIG. 5A.

FIG. 6A is a cross-sectional view of a core according to an embodiment of the present disclosure.

FIG. 6B is a partial enlarged view of FIG. 6A.

FIG. 7A is a cross-sectional view of a core according to an embodiment of the present disclosure.

FIG. 7B is a partial enlarged view of FIG. 7A.

FIG. 8A is a cross-sectional view of a core according to an embodiment of the present disclosure.

FIG. 8B is a partial enlarged view of FIG. 8A.

FIG. 9 is a perspective view of an inductor according to an embodiment of the present disclosure.

FIG. 10 is a perspective view of an inductor according to an embodiment of the present disclosure.

FIG. 11 is a perspective view of an inductor according to an embodiment of the present disclosure.

FIG. 12A is a perspective view of an inductor according to an embodiment of the present disclosure.

FIG. 12B is a cross-sectional view of the inductor of FIG. 12A taken along the line A-A.

FIG. 12C is a perspective view of the conductive structure of the inductor of FIG. 12A.

FIG. 13 is a perspective view of a transformer according to an embodiment of the present disclosure.

FIG. 14 is a block diagram of a buck converter that may employ an inductor according to an embodiment of the disclosure.

FIG. 15 is a flow chart of a method of making a core according to an embodiment of the disclosure.

FIG. 16 is a graph depicting the relationship between coercivity and saturation polarization of various materials.

FIG. 17 is a graph depicting the relationship between coercivity, saturation polarization, and cost of various materials.

FIG. 18 is a graph depicting the relationship between permeability and saturation polarization of various materials.

### DETAILED DESCRIPTION

Although the claimed subject matter will be described in terms of certain embodiments and examples, other embodiments and examples, including embodiments and examples that do not provide all of the benefits and features set forth herein, are also within the scope of this disclosure. Various structural, logical, and process step changes may be made without departing from the scope of the disclosure.

To reduce eddy current loss, inductor cores have been formed from laminated layers of magnetic materials (laminated core) or compacted magnetic dust (dust core). Each has the goal of reducing the magnitude of eddy currents by dividing the magnetic core into a plurality of isolated domains. However, the thinnest laminated core layers are around 10 μm thick, making laminated cores unsuitable for very high frequency applications. Although dust cores may include particles having a particle size at low as 1 μm, dust cores have a lower density of the magnetic material and a lower magnetic permeability of the magnetic core. Further, it is difficult to mass-produce the high-purity and uniform magnetic nanoparticles required for use in dust cores, and then form them into compacts (e.g., compact layers) with even dispersion and high density. The resultant non-uniformity degrades performance of the dust core in an inductor. Conversely, embodiments of the present disclosure provide a core formed of very fine fibers (100 nm to 10 μm) that are uniformly aligned resulting in excellent performance in an inductor or other devices even at frequencies as high as 100 MHz.

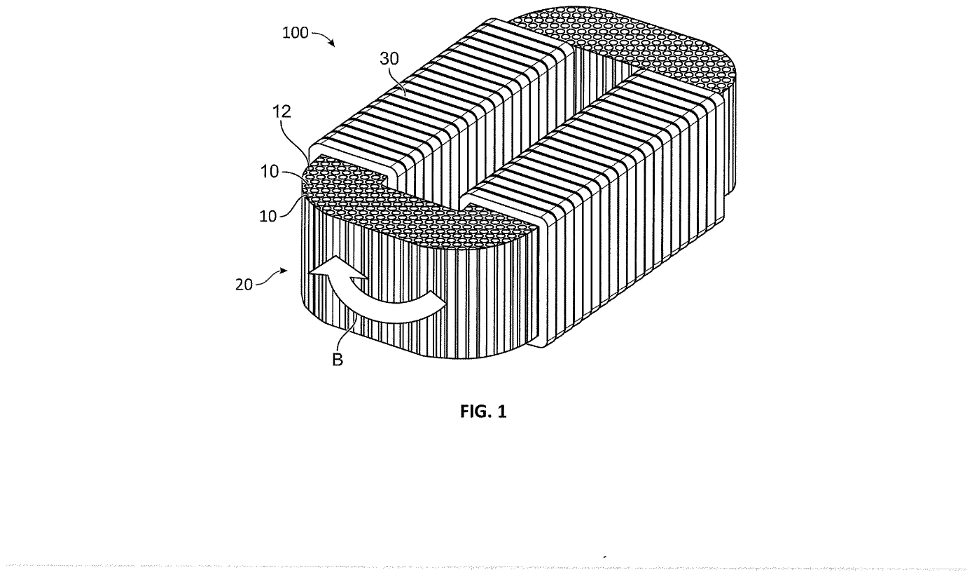

With reference to FIG. 1, an inductor 100 according to an embodiment of the present disclosure includes a core 20 formed of a plurality of fibers 10 that are axially aligned. The plurality fibers 10 may be aligned transverse to a magnetic field B within the core 20. In some embodiments, the plurality of fibers 10 are aligned perpendicular to the core 20. In some embodiments, the fibers 10 may each have an aspect ratio of at least 3, at least 5, or at least 10.

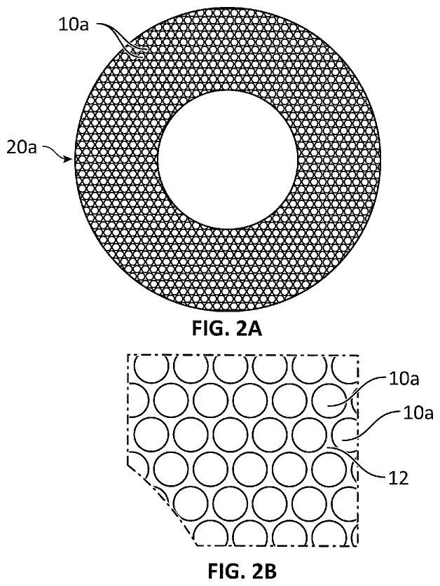

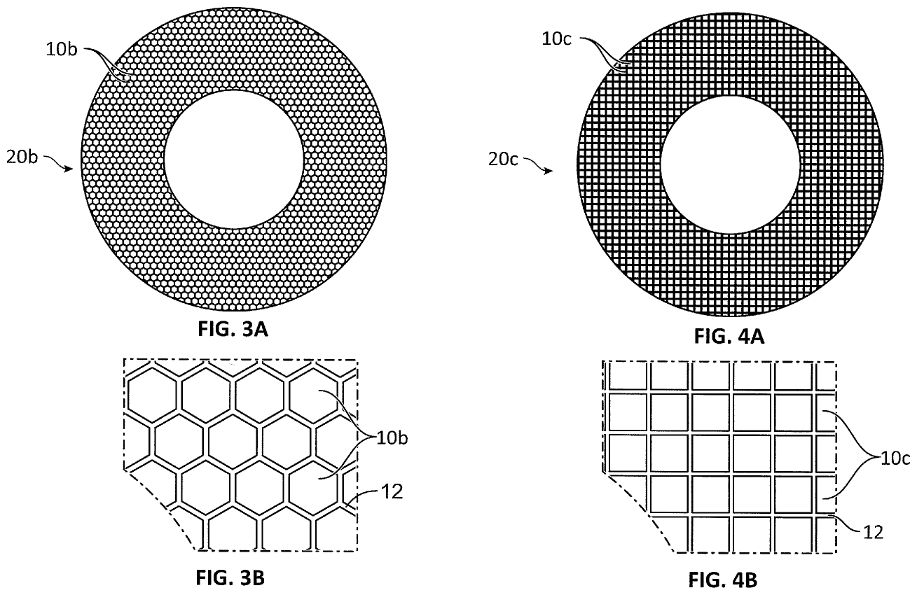

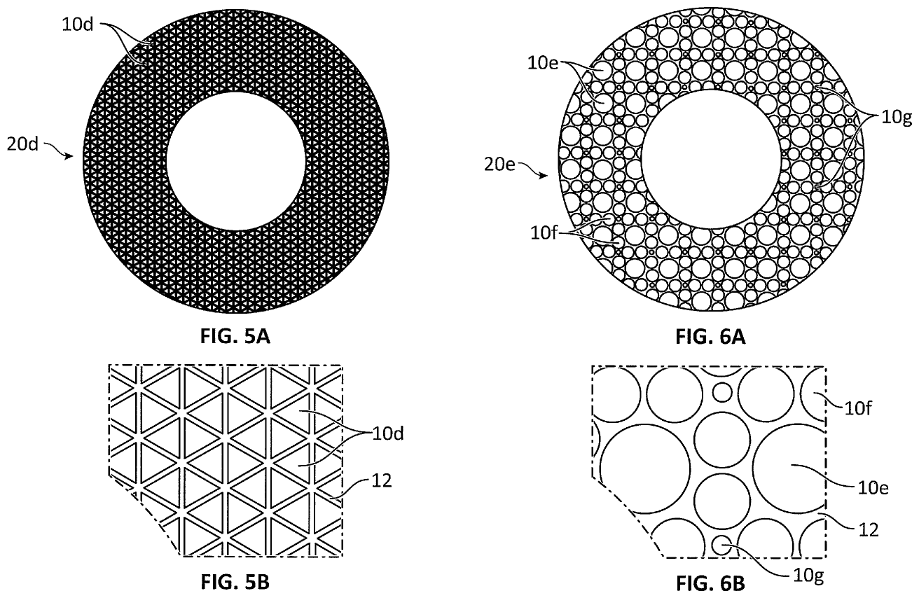

In some embodiments, a cross-sectional shape of the fibers 10 is circular, rectangular, triangular, hexagonal, or combinations thereof. For example, the core 20a in FIGS. 2A and 2B includes fibers 10a having a circular cross-sectional shape. The core 20b in FIGS. 3A and 3B includes fibers 10b having a hexagonal cross-sectional shape. The core 20c in FIGS. 4A and 4B includes fibers 10c having a square cross-sectional shape. The core 20d in FIGS. 5A and 5B includes fibers 10d having a triangular cross-sectional shape. Other cross-sectional shapes may be used, such as ovoid or regular or irregular polygons.

In some embodiments, the fibers 10 have a uniform cross-sectional shape. In other embodiments, the core 20 may include a first plurality of fibers having a first cross-sectional shape and a second plurality of fibers having a second cross-sectional shape that is different from the first cross-sectional shape. In such embodiments, the first and second pluralities of fibers may be interspersed randomly or in a predetermined pattern or they may be partitioned within the core 20.

In one or more embodiments, the fibers 10 are formed of a material having a higher magnetic permeability than air. In some embodiments, the fibers 10 are formed of a metal and/or a metal oxide. In some embodiments, the fibers 10 are formed of a ferromagnetic or ferrimagnetic material. In some embodiments, the fibers 10 are formed of a soft magnetic material. Magnetic materials can generally be classified into two main groups: soft and hard. Hard magnetic materials have high coercivity and are suitable for permanent magnets, whereas soft magnetic materials have low coercivity and are suitable for inductors, transformers, and the like. Generally, soft magnetic materials may be classified based on chemical composition (e.g., variations within the classes of NiFe, soft ferrites, SiFe, CoFe, or Fe) and/or based on atomic structure (i.e., nanocrystalline, amorphous, polycrystalline, and etc). Various materials in amorphous and nanocrystalline category generally are suitable for forming the fibers 10 provided that the manufacturing challenges associated with brittleness can be overcome. Properties of some materials that may be used for the fibers 10 are summarized in Table 1 below.

TABLE 1
Properties of NiFe and CoFe Alloys

| | ρ (μΩ cm) | Jₛ (T) | H_{c} (A/m) | μₘₐₓ × 1000 | |
|---|---|---|---|---|---|
| Fe64Ni36 | 75 | 1.3 | 40 | 20 | Invar |
| Fe50Ni50 | 45 | 1.6 | 7 | 15 | Isoperm |
| Fe52Ni48 | 45 | 1.6 | 8 | 180 | |
| Fe44Ni56 | 35 | 1.5 | 1 | 300 | |
| Fe20Ni80 | 16 | 1.1 | 0.4 | 100 | Permalloy |
| Fe16Ni79Mo5 | 60 | 0.8 | 0.4 | 550 | Supermalloy |
| Fe16Ni77Cu5Cr2 | 56 | 0.75 | 0.8 | 500 | Mumetal |
| Fe50Co50 | 7 | 2.45 | 160 | 5 | Permendur |
| Fe49Co49V2 | 40 | 2.4 | 400 | 17 | Hiperco, vacoflux |

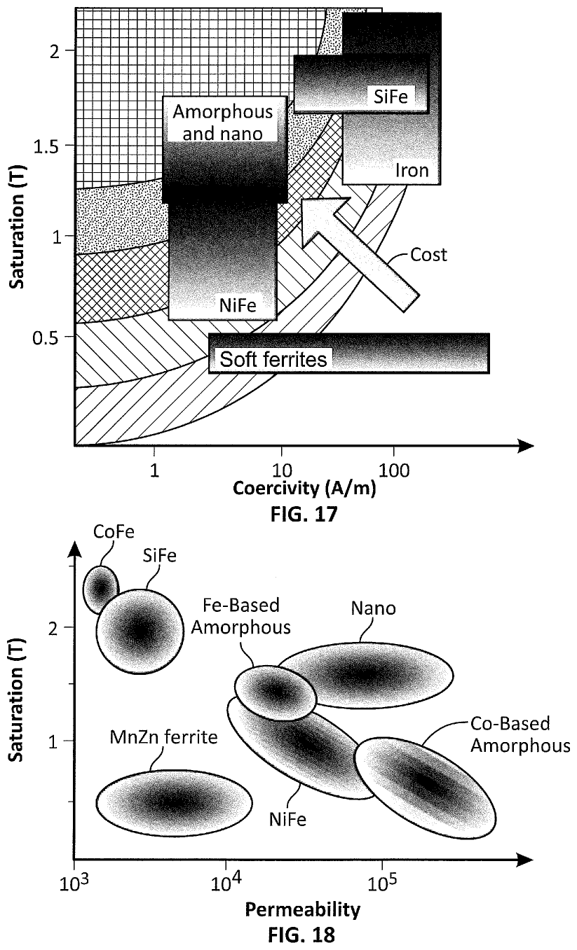

In some embodiments, the material for the fibers 10 is selected based on the following criteria: high saturation (e.g., greater than 1), low coercivity (e.g., less than 10 A/m), and high relative permeability (e.g., greater than 1000). In some embodiments, the material is selected to meet the coercivity and permeability ranges above and to maximize saturation (e.g., at least 1.5, at least 2, or greater than 2). In contrast, maximizing the permeability of the material (to, for example, greater than 100,000) may yield diminishing returns. FIGS. 16-18 graph the saturation of various magnetic materials against the coercivity, cost, and/or permeability thereof.

According to some embodiments, the fibers 10 comprise a nanocrystalline and/or amorphous soft magnetic material. In some embodiments, the fibers 10 comprise an iron alloy selected from NiFe (e.g., Ni₅₀Fe₅₀ Ni₄₈Fe₅₂, Ni₅₆Fe₄₄, or Ni₅₀Fe₂₀), SiFe, CoFe (e.g., Co₅₀Fe₅₀), or combinations thereof.

In some embodiments, the fibers 10 are uniform in composition. In other embodiments, the core 20 may include a first plurality of fibers made of a first material and a second plurality of fibers made of a second material that is different from the first material. In such embodiments, the first and second pluralities of fibers may be interspersed randomly or in a predetermined pattern or they may be partitioned within the core 20. For example, the core 20k depicted in FIGS. 8A and 8B includes first fibers 10k and second fibers 10m formed of different materials and provided in alternating rows.

According to embodiments of the present specification, the fibers 10 have a diameter of from 100 nm to 10 μm. In some embodiments, the fibers 10 have a diameter of at least 100 nm, at least 200 nm, at least 300 nm, at least 400 nm, at least 500 nm, at least 700 nm, at least 1 μm, or at least 2 μm and at most 10 μm, less than 10 μm, at most 8 μm, at most 5 μm, at most 3 μm, at most 2 μm, at most 1 μm, or at most 500 nm. It will be understood that the fiber diameters may range within any logical combination of the foregoing lower and upper limits, for example, from 200 nm to 5 μm or from 1 μm to 8 μm. In some embodiments, the fibers 10 may have a uniform diameter or substantially uniform diameter (e.g., varying by up to 10% or up to 20%). In other embodiments, the core 20 may include a first plurality of fibers having a first diameter and a second plurality of fibers having a second diameter that is different from the first diameter. In such embodiments, the first and second pluralities of fibers may be interspersed randomly or in a predetermined pattern or they may be partitioned within the core 20. For example, the core 20e depicted in FIGS. 6A and 6B includes first fibers 10e having a first diameter, second fibers 10f having a second diameter smaller than the first diameter, and third fibers 10g having a third diameter smaller than the second diameter. The pattern shown in FIGS. 6A and 6B provides for a denser packing of the fibers 10e, 10f, and 10g versus a configuration having circular fibers of uniform diameter.

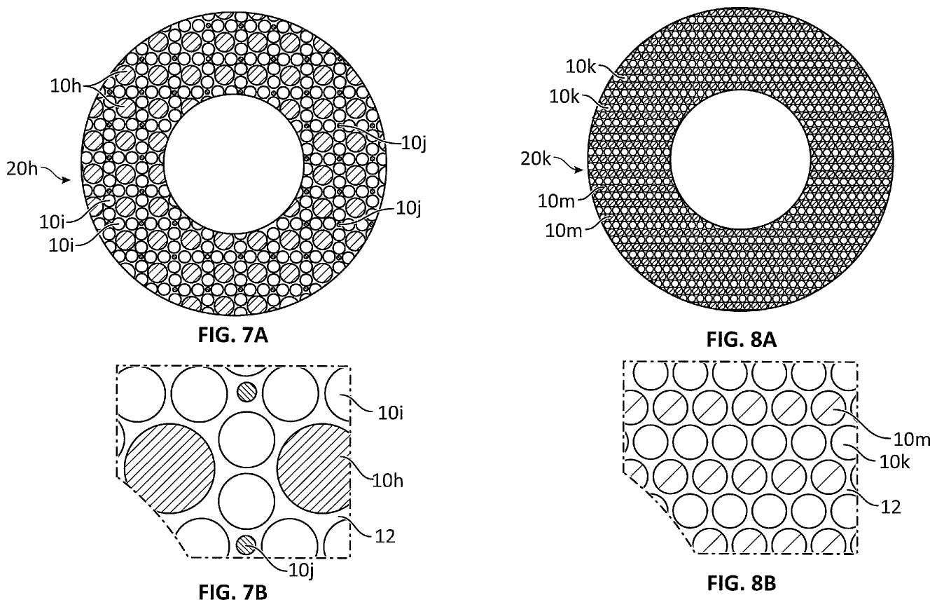

In some embodiments, the core 20 may include fibers 10 of varying diameter and of varying composition. In such embodiments, the distinct fibers 10 may be interspersed randomly or in a predetermined pattern or they may be partitioned within the core 20. For example, the core 20h depicted in FIGS. 7A and 7B includes first fibers 10h having a first diameter and formed of a first material, second fibers 10i having a second diameter smaller than the first diameter and formed of a second material different from the first material, and third fibers 10j having a third diameter smaller than the second diameter and formed of a third material different from the first and second materials.

In some embodiments, the core 20 may include fibers 10 having varying diameters, varying compositions, and varying cross-sectional shapes. In some embodiments, the core may include fibers having varying compositions and varying cross-sectional shapes.

Turning back to FIG. 1, the core 20 further includes an electrically insulating material 12 disposed between the fibers 10 to electrically insulate them from one another. The composition of the insulating material 12 is not particularly limited and may include a resin material. A thickness of the insulating material 12 should be sufficient to electrically insulate the fibers 10. In general, as the fiber diameter decreases, the relative amount of the insulating material 12 in the core 20 will increase.

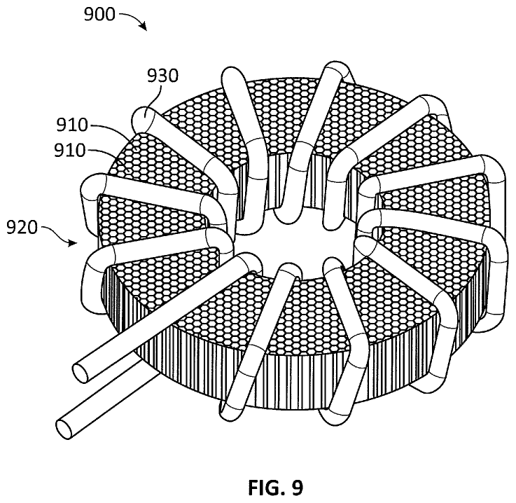

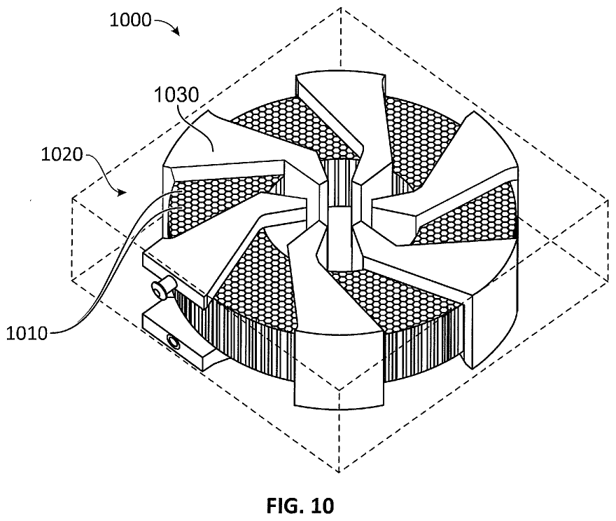

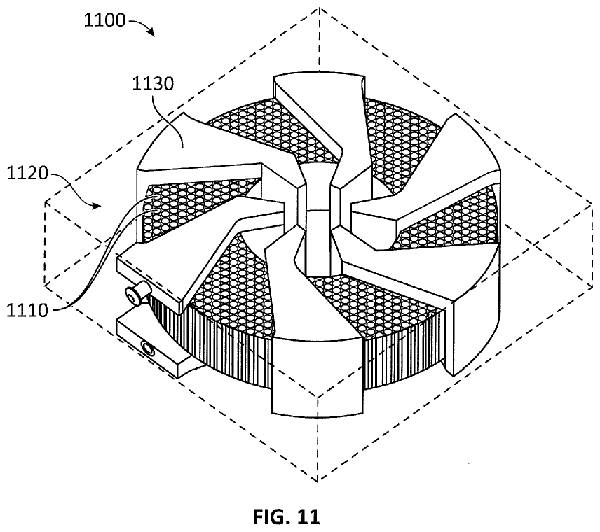

The inductor 100 includes a conductive structure 30 in proximity to the core 20. In FIG. 1, the conductive structure 30 is conductive wire wrapped around the core 20. For example, as shown in FIG. 9, an inductor 900 includes a toroidal core 920 formed of a plurality of fibers 210 having a conductive structure 930 (winding) wound about the toroidal core 920. In some embodiments, the conductive structure 30 may include two or more windings (e.g., as in a coupled inductor), wherein a coupling factor may be different for each of the windings. The shape, composition, and configuration of the conductive structure 30 is not particularly limited. For instance, FIGS. 10 and 11 depict an alternate configuration of the conductive structures 1030 and 1130, which are solid, shaped assemblies rather than wires. In FIGS. 10 and 11, the inductors 1000 and 1100 include the conductive structures 1030 and 1130 disposed about the cores 1020 and 1120 each respectively formed of a plurality of fiber 1010 and 1110.

In operation, an electric current is passed through the conductive structure 30, which creates a magnetic field. The magnetic field penetrates the core 20 and is amplified or modified (e.g., concentrated or redirected) by a magnetic field B induced within the core 20. In some embodiments, the structure and/or orientation of the fibers 10 provides improved characteristics such as reduced eddy current loses. Additionally, the density of the fibers 10 within the core 20 can be controlled, for example, by selection of the material, shape, and/or size of the fibers 10, selection of the material and/or thickness of the insulating material 12, and/or processing conditions (e.g., compacting the core 20 at a predetermine pressure). By controlling the density of the fiber material density within the core 20, the permeability of the core 20 may also be controlled.

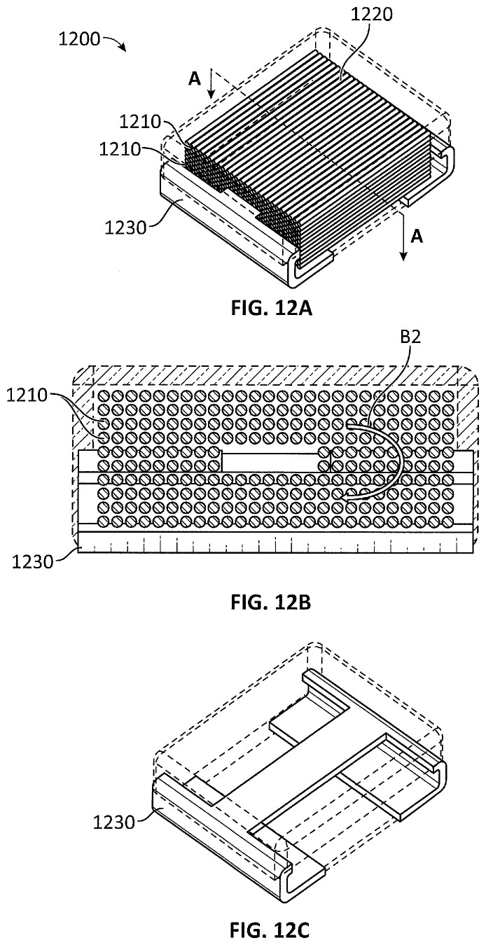

Although toroidal core shapes have been discussed above, the disclosure is not limited to a particular core shape. The core 20 disclosed herein may be, for example, rectangular or E-shaped, or may include a distributed air gap. An example of an alternate core shape is shown in FIG. 12A, wherein a straight-line inductor 1200 includes a core 1220 formed of a plurality of fibers 1210 that is disposed about the conductive structure 1230. Additional views are shown in FIGS. 12B and 12C. In this embodiment, at least a portion of the conductive structure 1230 passes through the core 1220. As above, the fibers 1210 are axially align and transverse or perpendicular to a magnetic field B2 of the core 1220.

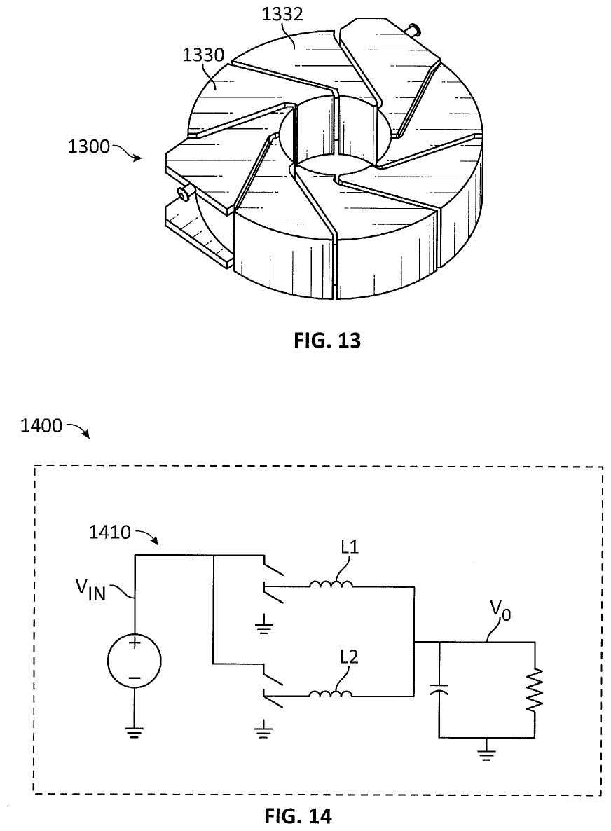

The core described herein may be used in a variety of electrical devices such as the inductors (or transformers) described herein (e.g., within an electronic device such as a computer, mobile phone, or any other type of electronic device). In some embodiments, the core may be included in a transformer, as shown in FIG. 13. In FIG. 13, the transformer 1300 includes a primary winding 1330 and a secondary winding 1332 each wrapped about the core (not shown, as it is under the windings).

In some embodiments, the core may be incorporated into an inductor and one or more of said inductors may be included in a circuit. For example, FIG. 14 depicts a buck converter 1410 (e.g., within an electronic device 1400) including two inductors L1 and L2, each of which may be inductor 100, 200, 300, 400, or 500. In some embodiments, the core may be incorporated into an inductive-based power converter, such as a boost converter or a buck-boost converter. In some embodiments, the core may be incorporated into a charge pump, for example, in an inductor coupled to

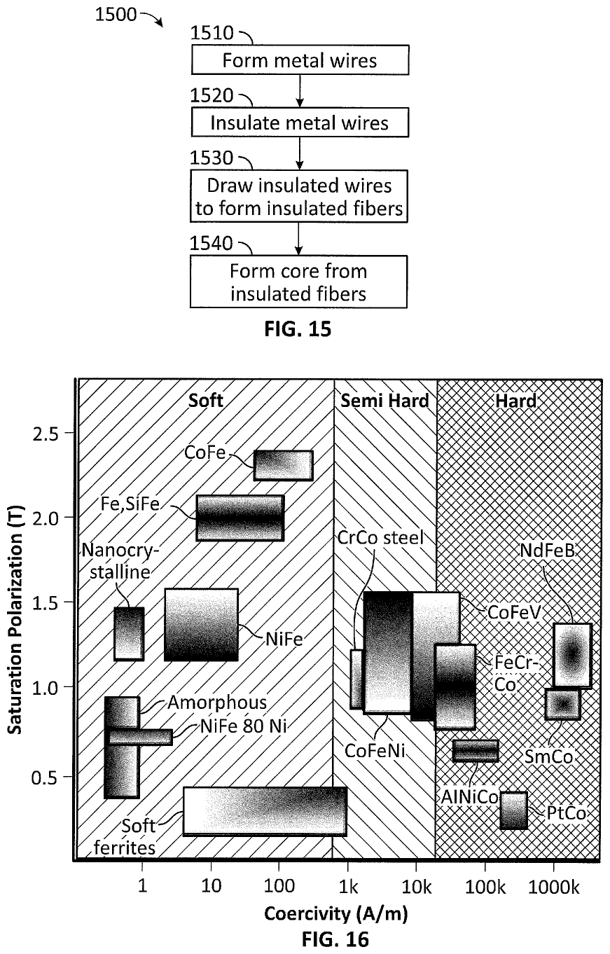

With reference to FIG. 15, a method 1500 of forming a core is also disclosed herein. The method 1500 includes a step 1510 of forming metal wires. The metal may be, for example, a solid wire or compacted metal powder and the composition of the metal may include a metal, a metal oxide, the materials disclosed above with reference to the fibers 10, or combinations thereof. After or concurrent with forming the metal wires in step 1510, the method 1500 includes a step 1520 of insulating the metal wires within an electrically insulating material. The insulating material may be as disclosed above and, in some embodiments, is a resin. In some embodiments, the insulating material may be present as a coating or a sheathing about the metal wires.

Next, the method 1500 includes a step 1530 of drawing the insulated metal wires into insulated fibers. The drawing step 1530 may be conducted at an elevated temperature of, for example, at least 100° C., at least 200° C., at least 300° C., or about 300° C. Drawing may be conducted in stages which each stage further reducing the fiber diameter. The drawing step 1530 results in fibers having diameters and cross-sectional shapes as described above. Additionally, the resultant insulated fibers have a solid, continuous metal core and a coating or sheathing of the insulating material disposed thereabout. This is the case even when the starting metal wire material comprises metal particles or powder. The drawing step 1530 may include drawing individual insulated metal wires to yield a single insulated fiber or drawing bundles containing a plurality of the insulated metal wires to yield a bundle of insulated fibers.

Lastly, the method 1500 includes a step 1540 of forming the core from a plurality of the insulated fibers. In some embodiments, step 1540 includes aggregating individually drawn insulated fibers or aggregating bundles of insulated fibers that were drawn together. Aggregating includes axially aligning the insulated fibers and may include compacting the insulated fibers or bundles. In some embodiments, the drawing step 1530 provides a bundle of insulated fibers that includes a sufficient number of fibers to form the core. In some embodiments, step 1540 includes cutting the plurality of insulated fibers in a fiber transverse direction to provide a desired fiber length (corresponding to a core thickness or length). In some embodiments, step 1540 includes cutting the plurality of insulated fibers in a fiber axial direction to provide a core shape, such as those described above. In other embodiments, step 1540 may include an extrusion process to provide the desired core shape. In yet other embodiments, step 1540 may include a molding step in conjunction with the aggregating to compact the insulated fibers into the desired core shape.

In some embodiments, step 1540 involves combining insulated fibers of varying composition, cross-sectional shape, and/or diameter to provide a core such as those discussed above with respect to FIGS. 2A-8B. In other embodiments, the variations in fiber type may be a result of the drawing step 1530. For instance, the drawing step 1530 may include bundling insulated metal wires having varying compositions and drawing them together.

An apparatus has been described herein. The apparatus includes a core and a conductive structure in proximity to the core. The core includes a plurality of fibers that are axially aligned and configured to be transverse to a magnetic field within the core and further includes an electrically insulating material disposed between the fibers. The apparatus may include any of the following features or combinations thereof:
wherein the plurality of fibers are configured to be perpendicular to the magnetic field within the core;
wherein the fibers each have an aspect ratio of at least 3 and a diameter of 100 nm to 10 μm;
wherein the core comprises a first surface and a second surface opposite the first surface; and wherein each of the fibers extends from the first surface to the second surface;
wherein the fibers comprise a cross-section shape that is circular, rectangular, triangular, hexagonal, or a combination thereof;
wherein the core is toroidal and the conductive structure comprises a conductive wire wound about the core;
further comprising a second conductive wire wound about the core; and/or
wherein the core is positioned around the conductive structure such that at least a portion of the conductive structure passes through the core.

The apparatus may be an inductor, may be a transformer or form a component of a transformer, and/or may be incorporated into an electric device

A core has been described herein. The core includes a plurality of fibers, each comprising a ferromagnetic material and an electrically insulating material disposed between the fibers of the plurality of fibers, wherein the fibers are axially aligned. The core may include any of the following features or combinations thereof:
wherein the plurality of fibers is configured to be transversal to a magnetic field of the core;
wherein the fibers each have an aspect ratio of at least 3 and a diameter of 100 nm to 10 μm;
wherein the fibers comprise a cross-section shape that is circular, rectangular, triangular, hexagonal, or a combination thereof;
wherein the fibers comprise first fibers having a first cross-sectional shape and second fibers having a second cross-sectional shape that is different from the first cross-sectional shape;
wherein the fibers comprise first fibers having a first diameter and second fibers having a second diameter that is less than the first diameter; and wherein the first fibers and the second fibers are interspersed within the core;
wherein the fibers comprise first fibers formed of a first material and second fibers
formed of a second material that is different from the first material; and wherein the first fibers and the second fibers are interspersed within the core; and/or
wherein the fibers have a uniform diameter, a uniform cross-sectional shape, and/or a uniform composition.

The core may be incorporated into an electric component, such as an inductor or a transformer, and/or may be incorporated into an electric device.

A method of making a core has been described herein. The method includes providing an insulated wire comprising an electrically insulating material wrapped about a metal structure, wherein the metal structure comprises a metal and/or a metal oxide in the form of a metal wire or compacted metal powder; drawing the insulated wire to form an insulated fiber comprising a continuous fiber having a diameter of 100 nm to 10 μm and a coating layer of the electrically insulating material disposed about the fiber; and combining a plurality of the insulated fibers such that the insulated fibers are axially aligned. The method may include any of the following features or combinations thereof:
wherein the combining step comprises simultaneously drawing a plurality of the insulated wires;
wherein the simultaneous drawing is conducted at a temperature of at least 200° C.;
further comprising cutting the plurality of the insulated fibers in both a transverse direction and an axial direction;
wherein cutting in the axial direction forms the plurality of the insulated fibers into a toroid;
further comprising extruding plurality of the insulated fibers to form a toroid; and/or
wherein the drawing step comprises simultaneously drawing a plurality of the insulated wires to form a bundle comprising a plurality of the insulated fibers; and wherein the combining step comprises compacting a plurality of the bundles together.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. An apparatus comprising:
a core; and
a conductive structure in proximity to the core;
wherein the core comprises:
a plurality of fibers that are axially aligned and configured to be transverse to a magnetic field within the core; and
an electrically insulating material disposed between the fibers.

2. The apparatus of claim 1, wherein the plurality of fibers are configured to be perpendicular to the magnetic field within the core.

3. The apparatus of claim 1, wherein the fibers each have an aspect ratio of at least 3 and a diameter of 100 nm to 10 μm.

4. The apparatus of claim 3, wherein the core comprises a first surface and a second surface opposite the first surface; and
wherein each of the fibers extends from the first surface to the second surface.

5. The apparatus of claim 3, wherein the fibers comprise a cross-section shape that is circular, rectangular, triangular, hexagonal, or a combination thereof.

6. The apparatus of claim 1, wherein the core is toroidal and the conductive structure comprises a conductive wire wound about the core, further comprising a second conductive wire wound about the core.

7. The apparatus of claim 1, wherein the core is positioned around the conductive structure such that at least a portion of the conductive structure passes through the core.

8. A transformer comprising the apparatus of claim 6, wherein the conductive wire is a primary winding of the transformer and the second conductive wire is a secondary winding of the transformer.

9. A core for an inductor comprising:
a plurality of fibers, each comprising a ferromagnetic material; and
an electrically insulating material disposed between the fibers of the plurality of fibers;
wherein the fibers are axially aligned.

10. The core of claim 9, wherein:
the plurality of fibers is configured to be transversal to a magnetic field of the core; and
the fibers each have an aspect ratio of at least 3 and a diameter of 100 nm to 10 μm.

11. The core of claim 10, wherein the fibers comprise a cross-section shape that is circular, rectangular, triangular, hexagonal, or a combination thereof.

12. The core of claim 11, wherein the fibers comprise first fibers having a first cross-sectional shape and second fibers having a second cross-sectional shape that is different from the first cross-sectional shape.

13. The core of claim 11, wherein the fibers comprise first fibers having a first diameter and second fibers having a second diameter that is less than the first diameter; and
wherein the first fibers and the second fibers are interspersed within the core.

14. The core of claim 11, wherein the fibers comprise first fibers formed of a first material and second fibers formed of a second material that is different from the first material; and
wherein the first fibers and the second fibers are interspersed within the core.

15. The core of claim 11, wherein the fibers have a uniform diameter, a uniform cross-sectional shape, and/or a uniform composition.

16. A transformer comprising the core of claim 9.

17. A method of making a core for an inductor comprising:
providing an insulated wire comprising an electrically insulating material wrapped about a metal structure, wherein the metal structure comprises a metal and/or a metal oxide in the form of a metal wire or compacted metal powder;
drawing the insulated wire to form an insulated fiber comprising a continuous fiber having a diameter of 100 nm to 10 μm and a coating layer of the electrically insulating material disposed about the fiber; and
combining a plurality of the insulated fibers such that the insulated fibers are axially aligned.

18. The method of claim 17, wherein the combining step comprises simultaneously drawing a plurality of the insulated wires.

19. The method of claim 18, wherein the simultaneous drawing is conducted at a temperature of at least 200° C.

20. The method of claim 18, further comprising cutting the plurality of the insulated fibers in both a transverse direction and an axial direction, and wherein the cutting in the axial direction forms the plurality of the insulated fibers into a toroid.

21. The method of claim 18, further comprising extruding plurality of the insulated fibers to form a toroid.

22. The method of claim 17, wherein the drawing step comprises simultaneously drawing a plurality of the insulated wires to form a bundle comprising a plurality of the insulated fibers; and
wherein the combining step comprises compacting a plurality of the bundles together.
